(19) United States
(12) Patent Application Publication
(10) Pub. No.: US 2025/0163190 A1
(43) Pub. Date: May 22, 2025

(54) METHODS OF FORMING CATIONIC POLYMERS USING INITIATORS ACTIVATED ONLY BY ULTRAVIOLET LIGHT

(71) Applicant: SOLENIS TECHNOLOGIES, L.P., Wilmington, DE (US)

(72) Inventors: Christian Dollendorf, Neuss (DE); Markus Bröcher, Mülheim an der Ruhr (DE); Jeanette Bothe, Rheinberg (DE)

(73) Assignee: SOLENIS TECHNOLOGIES, L.P., Wilmington, DE (US)

(21) Appl. No.: 18/956,253

(22) Filed: Nov. 22, 2024

Related U.S. Application Data
(60) Provisional application No. 63/601,847, filed on Nov. 22, 2023.

(51) Int. Cl. C08F 2/50

(52) U.S. Cl. CPC C08F 2/50; C08F 2800/20

(57) ABSTRACT

Methods are provided for synthesizing a polymer product. The methods include combining an ultraviolet light-activated polymerization initiator and a nitrogen-containing vinyl monomer to form a reaction mixture. The initiator is radicalized only by exposure to ultraviolet light. The reaction mixture has an active content of reactive components present in an amount of at least about 20 weight % based on a total weight of the reaction mixture. The methods further include exposing the reaction mixture to ultraviolet light produced from an ultraviolet light source to form a polymer product. The polymer product includes a reaction product of the initiator and the nitrogen-containing vinyl monomer. The polymer product is comminutable to form discrete granules of the polymer product.

### CROSS-REFERENCE TO RELATED APPLICATIONS

This application claims the benefit of U.S. Provisional Application No. 63/601,847, filed Nov. 22, 2023.

### TECHNICAL FIELD

The present disclosure generally relates to polymer production, and more particularly relates to polymerization of nitrogen-containing vinyl monomers.

### BACKGROUND

Cationic vinyl polymers are used as flocculating agents in various applications including wastewater treatment, ore and coal processing, and paper manufacturing. Examples of cationic vinyl polymers formed from nitrogen-containing monomers include polyvinylamine (PVAm) and polyacrylamide (PAM).

The general processes for synthesizing cationic vinyl polymers are known in the industry. In one process, nitrogen-containing vinyl monomers are combined with a polymerization initiator to effectuate a polymerization reaction. To form polyvinylamine, in particular, the nitrogen-containing vinyl monomer is a vinyl carboxamide, and acid or base is added to the resulting intermediate polymer formulation to effectuate a hydrolysis reaction, forming a cationic vinyl polymer dispersed in aqueous solution. To form polyacrylamide, amide-containing monomers, such as acrylamide and/or (2-acryloyloxy-ethyl)-trimethylammonium chloride, are polymerized.

Traditionally, the polymerization processes are carried out with a dilute aqueous solution of monomers. This process is called water-solution polymerization or emulsion polymerization. An emulsion polymerization forms the polymer in an aqueous solution (in liquid form). Sometimes it is desired to provide polymers in particulate form instead of in liquid form. Providing polymers in particulate form is beneficial because it allows for transportation and storage of larger quantities of active polymer, and a longer shelf life of the polymer composition, than when the polymer is provided in liquid or gel form.

Polyacrylamide polymer may be provided in particulate form, for example, through an adiabatic gel polymerization process, applying heat to activate a heat-activated azo-based polymerization initiator, or using a redox initiator system. In gel polymerization processes, the reaction mixture may have a high active content, e.g., greater than 20 weight % of reactive components based on the total weight of the reaction mixture. The resulting polymer product is comminutable to form granules of the polymer product. A gel polymerization at maximized active content is also beneficial because it increases sustainability by requiring less water, less energy consumption to dry to product, reduced costs, and a reduced carbon footprint.

However, there are problems with the existing adiabatic gel polymerization processes. For example, polyvinylformamide, which is the precursor to polyvinylamine, cannot be acceptably formed through conventional gel polymerization because the monomers may break down into byproducts at a higher rate than they do in an emulsion polymerization process due to difficulties with controlling reaction temperature during adiabatic gel polymerization using heat-activated azo-based initiators. Such byproducts may inhibit the polymerization reaction or cause other undesirable effects. When forming polyacrylamide through conventional gel polymerization using heat-activated azo-based initiators or redox initiator systems at higher than standard active content, undesirable crosslinking occurs in the formed polymer. This results in a lower quality or lower purity polymer product.

Further, when the active content of the reaction mixture in an adiabatic gel polymerization is maximized, and/or when a polymer with maximized weight average molecular weight is produced through an adiabatic gel polymerization, the resulting polymer product often has a minimized solubility in solution, resulting in an excessive amount of insoluble gel in a solution of the polymer product.

Accordingly, it is desirable to provide methods of synthesizing polymer products from nitrogen-containing vinyl monomers through adiabatic gel polymerization processes in a manner that minimizes byproduct formation and/or crosslinking. Furthermore, it is desirable to produce a polymer product through adiabatic gel polymerization with minimized content of insoluble gel in a solution of the polymer product. Furthermore, other desirable features and characteristics of the present disclosure will become apparent from the subsequent detailed description and the appended claims, taken in conjunction with the accompanying drawings and this background.

### BRIEF SUMMARY

Methods are provided for synthesizing a polymer product. The methods include combining an ultraviolet light-activated polymerization initiator and a nitrogen-containing vinyl monomer to form a reaction mixture. The initiator is radicalized only by exposure to ultraviolet light. The reaction mixture has an active content of reactive components present in an amount of at least about 20 weight % based on a total weight of the reaction mixture. The methods further include exposing the reaction mixture to ultraviolet light produced from an ultraviolet light source to form a polymer product. The polymer product includes a reaction product of the initiator and the nitrogen-containing vinyl monomer. The polymer product is comminutable to form discrete granules of the polymer product.

### DETAILED DESCRIPTION

The following detailed description is merely exemplary in nature and is not intended to limit the present disclosure or the application and uses thereof. Furthermore, there is no intention to be bound by any theory presented in the preceding background or the following detailed description.

The methods as provided herein enable synthesis of a polymer product from nitrogen-containing vinyl monomers through an adiabatic gel polymerization process with minimized byproduct formation and/or minimized crosslinking as compared to conventional adiabatic gel polymerization processes. The methods provide a modified adiabatic gel polymerization process, using a UV initiator that is radicalized only by UV radiation. Such a UV-only initiator allows for more reaction control compared to traditional heat-activated initiators because the reaction can be immediately started and stopped by turning a UV light source on and off to immediately activate and deactivate the UV-only initiator. Controlling the reaction in this way can minimize decomposition of the initiator and thus minimize crosslinking. Controlling the reaction can also regulate the reaction temperature, which can minimize the production of byproducts. As a result, high weight average molecular weight polymer can be produced at maximized active content without excessive production of byproducts and/or crosslinking, and with a minimized amount of insoluble gel-like material in a solution of the polymer product, depending upon the type of nitrogen-containing vinyl monomers used.

Gel polymerization processes can produce polymer products that can be comminuted or granulated, unlike products of conventional emulsion polymerization. A higher active content is advantageous because it allows for a higher production efficiency. Gel polymerization at high active content is also beneficial because it leads to reduced water consumption, reduced energy consumption, reduced carbon footprint, reduced costs, and increased sustainability. However, previously, carrying out a gel polymerization at high active content yielded a polymer product with an insufficient weight average molecular weight. Increasing the weight average molecular weight of the polymer product yielded a polymer product with excessive insoluble gel-like material (which is unusable for the applications of the polymer product) in a solution of the polymer product. It has been found that using a polymerization initiator that is activated only by UV light, in combination with a UV light source, allows for the production of a polymer product with maximized weight average molecular weight through gel polymerization at higher than standard active content while minimizing the amount of insoluble polymer product. Without being bound by any theory, it is believed that the use of the UV-only initiator may decrease the amount of byproduct formation and/or crosslinking during the gel polymerization process as compared to conventional heat activated initiators, resulting in the above described effects on the quality of the polymer product.

Unless specifically stated or obvious from context, as used herein, the term “about” is understood as within a range of normal tolerance in the art measured using standard measurement devices, for example within 2 standard deviations of the mean for a particular measurement device. “About” can be understood as within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

As used herein, the term “active content” with reference to the reaction mixture refers to the content of reactive components present in the reaction mixture based on a total weight of the reaction mixture. With reference to the reaction mixture, the term “active content” is synonymous with the terms “monomer solids” and “monomer phase concentration.” The term “active content” with reference to a polymer product refers to the content of active polymer present in the polymer product based on a total weight of the polymer product.

As used herein, the term “activated,” with reference to a polymerization initiator, refers to the radicalization or initiation of the initiator. For example, if a polymerization initiator is “activated” only by ultraviolet (UV) light, this means that the initiator is radicalized only by UV light and will initiate a polymerization reaction only upon exposure to UV light but will not radicalize when exposed to heat.

The methods as provided herein are directed to synthesis of a polymer product. The polymerization methods include combining a UV initiator only sensitive to UV light and a nitrogen-containing vinyl monomer to form a reaction mixture.

The UV light-activated polymerization initiator is activated only by exposure to UV light, not by exposure to heat or by any other method. Examples of UV light-activated initiators that are activated only by exposure to UV light include 2-Hydroxy-2-methyl-1-phenyl-1-propanone, benzophenone, 4′-Hydroxyacetophenone, methyl benzoylformate, 2,2-Dimethoxy-2-phenylacetophenone, alpha-ketoglutaric acid, Camphorquinone, (1-Hydroxycyclohexyl)-phenylketone, 2α-Hydroxy-4-(2-hydroxyethoxy)-2α-methylpropiophenone, ethyl 2-oxopropanoate, ethyl 3-methyl-2-oxoabutanoate, 4,4-dimethyldihydrofurane-2,3-dione, ethyl phenylglyoxylate and combinations thereof. Alternatively, the UV light-activated polymerization initiator may be an azo-based polymerization initiator which is activated only by UV light and not by heat. The reaction mixture may include only one polymerization initiator that is initiated only by UV light, or the reaction mixture may include two or more polymerization initiators that are initiated only by UV light.

In embodiments, the reaction mixture also includes a co-initiator in addition to the polymerization initiator(s) that are activated only by UV light. The co-initiator is activated at least by a method other than UV light, such as heat. In an embodiment, the co-initiator is methyldiethanolamine. In other embodiments, the co-initiator is an azo-based initiator. Examples of azo-based initiators include 2,2′-Azobis-(2-methyl-propionamidine)-dihydrochloride, 2,2′-Azobis(2-methylpropionitrile), 2-2′-azo-bis-(2-methyl-butyronitrile), 2,2′-Azobis[2-(2-imidazolin-2-yl)propane]dihydrochloride, azo-bis-isobutyronitrile, azo-bis-(2-amidonopropane)dihydrochloride, 4,4′-azobis(4-cyanovaleric acid), 2,2′-azobis[2-methyl-N-(2-hydroxyethyl)propionamide], 2,2′-azobis[N-(2-carboxyethyl)-2-methylpropionamidine]tetrahydrate, and combinations thereof.

As used herein, the term “vinyl monomer(s)” refers to monomer(s) which have (H₂C═C—) group in their structure. Vinyl monomers could alternatively be defined as ethylenically unsaturated monomers. The term “nitrogen-containing vinyl monomer(s)” refers to vinyl monomer(s) that contain at least one nitrogen atom. Examples of nitrogen-containing vinyl monomers include, but are not limited to, acrylamide, N-vinylcarboxamide, N-vinylpyrrolidone, acrylonitrile, or combinations thereof.

In embodiments, the nitrogen-containing vinyl monomer present in the reaction mixture is an acrylamide monomer. The acrylamide monomer may be the only nitrogen-containing vinyl monomer present in the reaction mixture. Alternatively, the reaction mixture may contain other nitrogen-containing vinyl monomers in addition to the acrylamide monomer. For example, the reaction mixture may also contain diallyldimethylammonium chloride (DADMAC), acrylamidopropyltrimethyl ammonium chloride (APTAC), methacrylamidopropyltrimethyl ammonium chloride (MAPTAC), (3-acrylamidopropyl) trimethylammonium chloride (DIMAPA-Q), (2-acryloxyloxy-ethyl)-trimethylammonium chloride (DMA3Q), quaternary ammonium salts of dimethylaminoethyl methacrylate, quaternary ammonium salts of dimethylaminoethyl methacrylate, and combinations thereof.

In embodiments, the nitrogen-containing vinyl monomer is selected from one or more N-vinylcarboxamide monomers having the general formula I

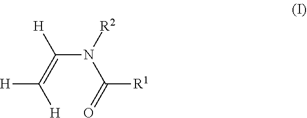

wherein R¹ and R², respectively, are either H or C₁ to C₆ alkyl groups. In embodiments, N-vinylcarboxamide monomer is selected from N-vinylformamide, N-vinyl-N-methylformamide, N-vinylacetamide, N-vinyl-N-methylacetamide, N-vinyl-N-ethylacetamide, N-vinylpropionamide, N-vinyl-N-methyl-propionamide, N-vinylbutyramide, copolymers of N-vinylformamide and combinations thereof. For example, in some embodiments, if R¹ and R² are both H, then the N-vinylcarboxamide monomer of formula I is N-vinylformamide. In other embodiments, if R¹ and R² are both methyl groups, then the N-vinylcarboxamide monomer having the formula I is N-vinyl-N-methylacetamide. There may be only one N-vinylcarboxamide monomer present in the reaction mixture, or there may be two or more N-vinylcarboxamide monomers present in the reaction mixture. The N-vinylcarboxamide monomer(s) may be the only nitrogen-containing vinyl monomer(s) present in the reaction mixture. Alternatively, the reaction mixture may contain other nitrogen-containing vinyl monomers having a formula different from formula I in addition to the N-vinylcarboxamide monomer(s).

In embodiments, the nitrogen-containing vinyl monomer(s) may include N-alkyl amides of α,β-ethylenically unsaturated monocarboxylic acids chosen from, for example, N-methylacrylamide, N-methylmethacrylamide, N-isopropylacrylamide, N-isopropylmethacrylamide, N-ethyl acrylamide, N-ethyl methacrylamide, N-(n-propyl)acrylamide, N-(n-propyl)methacrylamide, N-(n-butyl)acrylamide, N-(n-butyl)methacrylamide, N-(tert-butyl)acrylamide, N-(tert-butyl)methacrylamide, N-(n-octyl)acrylamide, N-(n-octyl)methacrylamide, N-(1,1,3,3-tetramethylbutyl)acrylamide, N-(1,1,3,3-tetramethylbutyl)methacrylamide, N-(2-ethylhexyl)acrylamide, N-(2-ethylhexyl-methacrylamide and combinations thereof.

For example, a salt form of an N-alkyl-N′-vinylimidazolium can be 1-methyl-3-vinylimidazol-1-ium chloride, 1-methyl-3-vinylimidazol-1-ium methyl sulfate or 1-ethyl-3-vinylimidazol-1-ium chloride. For example, a salt form of an N-alkylated vinylpyridinium is 1-methyl-4-vinylpyridin-1-ium chloride, 1-methyl-3-vinylpyridin-1-ium chloride, 1-methyl-2-vinylpyridin-1-ium chloride or 1-ethyl-4-vinylpyridin-1-ium chloride. For example, a salt form of an acrylamidoalkyl trialkylammonium is acrylamidoethyl trimethylammonium chloride (trimethyl-[2-(prop-2-enoylamino)ethyl]ammonium chloride), acrylamidoethyl diethylmethylammonium chloride (diethyl methyl-[3-(prop-2-enoylamino)ethyl]ammonium chloride), acrylamidopropyl trimethylammonium chloride (trimethyl-[3-(prop-2-enoylamino)propyl]ammonium chloride) or acrylamidopropyl diethylmethylammonium chloride (diethyl methyl-[3-(prop-2-enoylamino)propyl]ammonium chloride). For example, a salt form of a methacrylic alkyl trialkylammonium is methacrylamidoethyl trimethylammonium chloride (trimethyl-[2-(2-methylprop-2-enoylamino)ethyl]ammonium chloride).

The reaction mixture has an active content of reactive components present in an amount of at least about 20 weight % based on a total weight of the reaction mixture. In embodiments, the reaction mixture has an active content of reactive components present in an amount of at least about 28 weight %, alternatively at least about 35 weight %, alternatively from about 20 weight % to about 55 weight %, alternatively from about 45 weight % to about 50 weight %, based on a total weight of the reaction mixture.

As one example, to produce a polymer product with minimized crosslinking through the methods provided herein, if the nitrogen-containing vinyl monomers present in the reaction mixture include acrylamide monomers, then the active content of the reaction mixture may be from about 33 weight % to about 40 weight %, while the reaction mixture in a conventional gel polymerization process may be limited to a maximum of from about 28 weight % to about 32 weight % active content, based on a total weight of the reaction mixture. In one particular embodiment, to produce a polymer product containing a copolymer of acrylamide and (2-acryloyloxy-ethyl)-trimethylammonium chloride with a 75 weight % charge with minimized crosslinking through the methods provided herein, the active content of the reaction mixture may be from about 45 weight % to about 50 weight %, while the reaction mixture in a conventional gel polymerization process may be limited to a maximum of from about 40 weight % to about 45 weight % active content, based on a total weight of the reaction mixture.

Carrying out a gel polymerization process at a maximized active content is beneficial because it allows for the production of a maximized volume of product per time interval, leading to a higher yield and higher production efficiency compared to conventional gel polymerization processes. Having a maximized active content in the reaction mixture while minimizing crosslinking and/or byproduct formation leads to a maximized production efficiency without adversely affecting the quality of the polymer product. Further, carrying out a gel polymerization process at a maximized active content allows for use of a minimized amount of water. The amount of energy needed to dry the product is also minimized, leading to reduced costs, reduced carbon footprint, and increased sustainability compared to a standard polymerization process.

The methods as provided herein further include exposing the reaction mixture to UV light produced from a UV light source to form a polymer product. In embodiments, the UV light source produces light having a wavelength from about 10 nm to about 400 nm, alternatively from about 300 nm to about 400 nm, alternatively from about 350 nm to about 370 nm, alternatively from about 360 nm to about 370 nm. In one particular embodiment, the UV light source produces light having a wavelength of about 365 nm.

In embodiments, the UV light source is a UV light-emitting diode (LED). The embodiment in which the UV light source is a UV LED is beneficial because, unlike UV tube lights and other conventional UV light sources, the UV LED can be tailored to emit a narrow band of wavelengths of UV light. Specifically, the narrow band of wavelengths of UV light emitted by the UV LED can be tailored to match up with the activation wavelength of the polymerization initiator that is only activated by UV light. This matching of the wavelengths allows increased control of initiator decomposition and prolonged polymerization. This is important because decomposition of the polymerization initiator may initiate polymer chain growth and crosslinking. Further, the UV LED provides enough irradiation intensity to reduce the amount of residual monomers after polymerization has finished. The UV LED is much more efficient than standard UV light sources. The UV LED has a longer lifetime and a lower energy consumption than standard UV light sources, leading to reduced costs, reduced carbon footprint, and increased sustainability.

In embodiments, the UV light source is selectively modulated during the exposure of the reaction mixture to the UV light produced from the UV light source. As used herein, the term “modulating” means switching the UV light source on or off, or adjusting the intensity of the UV light produced from the UV light source. Modulating the UV light source is beneficial because it allows for reaction control. Turning the UV light source on and off allows the reaction to be immediately started or stopped. Adjusting the intensity of the UV light source allows control of reaction conditions such as the rate of reaction, the temperature of the reaction mixture, and the reaction time. The starting intensity of the UV light source may be from about 10 μW/cm² to about 2000 μW/cm², alternatively from about 70 μW/cm² to about 600 μW/cm², 50 μW/cm² to about 200 μW/cm², alternatively from about 100 μW/cm² to about 200 μW/cm², alternatively from about 130 μW/cm² to about 150 μW/cm². The ending intensity of the UV light source may be from about 5000 μW/cm² to about 40,000 μW/cm², alternatively from about 8000 μW/cm² to about 12000 μW/cm², alternatively from about 8000 W/cm² to about 9000 μW/cm². In embodiments, the intensity of the UV light source is increased at a certain point in the reaction based on an observed temperature of the reaction mixture, elapsed time, or degree of polymerization in the reaction mixture. In embodiments, the intensity is increased when the reaction mixture reaches its maximum temperature. In embodiments, the intensity is increased when the reaction mixture reaches a temperature of at least 10° C. below the maximum temperature, alternatively from about 10° C. to about 30° C. below the maximum temperature. The reaction mixture may be exposed to the increased intensity for a period of time after reaching the maximum temperature, for example for about 30 minutes after reaching the maximum temperature. In one particular embodiment, the starting intensity is about 140 μW/cm², and when the temperature of the reaction mixture reaches about 60° C., the intensity is adjusted to an ending intensity of about 8500 μW/cm².

In some embodiments, modulating the UV light source may decrease instances of crosslinking in the formed polymer. During the time when the reaction mixture is exposed to UV light, a polymerization reaction occurs. During the polymerization reaction, continued exposure to UV light may cause the polymerization initiator to decompose, which can initiate polymer chain growth and crosslinking. The ability to modulate the UV light source during the polymerization reaction allows for control of initiator decomposition, and thus allows for minimization of crosslinking.

In embodiments, reaction temperature may be important, and modulating the UV light source may allow for control of the temperature of the reaction mixture. Whereas gel polymerization with conventional heat-activated initiators makes temperature control difficult, gel polymerization using the initiators as described herein enables excellent temperature control because reaction temperatures nearly immediately begin to drop once the UV light source is modulated. For example, the UV light source may be modulated such that the temperature of the reaction mixture is maintained below about 70° C., alternatively below about 80° C., alternatively from about 70° C. to about 80° C. In embodiments, the reaction mixture may be controlled between a temperature of from about −5° C. to about 100° C., for the duration of the reaction. Controlling the temperature of the reaction mixture may decrease the production of byproducts from unreacted monomers. For example, with polyvinylcarboxamide synthesis, byproducts such as acetaldehyde may begin to form at a reaction temperature of about 70° C. with excessive byproduct formation observed at reaction temperatures of 80° C. and greater. Such byproducts may cause undesirable characteristics in the formed polymer and in the polymer product.

In embodiments, during the time when the reaction mixture is being exposed to UV light, the reaction mixture may change from an aqueous solution to a gel. As used herein, the term “gel” refers to a gelatinous material having the consistency of a gelled substance or gummy bear. The point in the polymerization reaction at which the reaction mixture changes from an aqueous solution to a gel, as measured based on mole percent of the reactive components in the reaction mixture having reacted as compared to the amount of the reactive components in the reaction mixture prior to commencing reaction, is referred to as the “gel point.” If the reaction mixture changes from an aqueous solution to a gel during the polymerization process, then the polymerization process is considered a gel polymerization process. In embodiments, in a gel polymerization process, the reaction mixture may have an active content of reactive components of at least 20 weight %, based on a total weight of the reaction mixture.

A gel polymerization process provides advantages because it allows for a maximized active content in the reaction mixture and in the resulting polymer product, leading to a maximized product yield per time interval, which is beneficial for production efficiency. The gel polymerization process also produces a polymer product which can be comminuted and formed into distinct granules of the product, which will be discussed in more detail. However, conventional gel polymerization processes generally yield a polymer product containing a polymer with a lower average weight average molecular weight than polymers produced through emulsion polymerization. Further, the polymer products produced from conventional gel polymerizations may have a higher insolubility in the final product than polymers produced through emulsion polymerization, leading to unusable product. The UV-only initiators, optionally in combination with the UV LEDs, used in the methods as provided herein mitigate these problems with gel polymerization.

As used herein, the term “polymer product” refers to the formulation produced through the method steps of combining a UV light-activated polymerization initiator and a nitrogen-containing vinyl monomer to form a reaction mixture, and exposing the reaction mixture to UV light produced from a UV light source. The polymer product contains the reaction product of the initiator and the nitrogen-containing monomer. The polymer product may also contain other components such as water, residual polymerization initiator, unreacted nitrogen-containing vinyl monomers, byproducts, and other impurities. The polymer product is comminutable to form discrete granules of the polymer product. The polymer product may be produced in gel form.

In embodiments, if the nitrogen-containing vinyl monomer present in the reaction mixture is an acrylamide monomer, then the polymer product contains a polymer containing amide functional groups that are derived from acrylamide monomers. For example, the polymer product may contain a polyacrylamide homopolymer or a polyacrylamide copolymer. If, in addition to an acrylamide monomer, other nitrogen-containing vinyl monomers are present in the reaction mixture, the polymer product contains a polyacrylamide copolymer. For example, in one particular embodiment, if the reaction mixture contains an acrylamide monomer and a (2-acryloxyloxy-ethyl)-trimethylammonium chloride monomer, the polymer product contains a polymer with acrylamide functional groups and (2-acryloxyloxy-ethyl)-trimethylammonium functional groups.

In other embodiments, if the nitrogen-containing vinyl monomer present in the reaction mixture is an N-vinylcarboxamide monomer having the formula I, then the polymer product contains a polymer containing carboxamide functional groups. The polymer may be a homopolymer, or the polymer may be a copolymer, particularly if other nitrogen-containing vinyl monomers are present in the reaction mixture in addition to the N-vinylcarboxamide monomer. For example, if N-vinylformamide monomers are present in the reaction mixture, then the polymer product contains a polyvinylformamide homopolymer or copolymer.

In embodiments, a 1 weight % solution of the polymer product, with 10 weight % sodium chloride in the solution, based on a total weight of the solution, has a dynamic viscosity of from about 200 mPas to about 2500 mPas, alternatively from about 400 mPs to about 1500 mPas, measured using a Brookfield viscometer at 10 rpm using an LV spindle number 2 at 20° C. Notably, the dynamic viscosity of the polymer product is higher than the dynamic viscosity of a polymer product produced through a conventional gel polymerization process that does not use a UV-only initiator and a UV light source. An increased dynamic viscosity is beneficial because it correlates with an increased weight average molecular weight.

In some embodiments, the polymer product undergoes further processing. For example, if the polymer product contains a polyvinylcarboxamide polymer, functional groups in the polyvinylcarboxamide polymer may be hydrolyzed to form vinylamine groups. Such hydrolysis may be conducted at a site remote from production of the polyvinylcarboxamide polymer, especially in instances where the polymer product is comminuted or granulated as described in further detail below.

The polymer product is comminutable to form discrete granules of the polymer product. Accordingly, in some embodiments, the polymer is comminuted and dried to form discrete granules of the polymer product. For example, in one embodiment, the polymer product may be cut and then dried by heating in an environment having a temperature of 120° C. for 10 minutes, followed by heating in an environment having a temperature of 100° C. for 30 minutes, followed by heating in an environment having a temperature of 90° C. for 40 minutes. Then, the dried polymer product may be ground to form granules of the dried polymer product. In embodiments, the granules have a particle-size of from about 100 microns to about 1000 microns, as measured by filtering the particles through sieves having apertures of varying sizes.

Comminuting the polymer product and providing the polymer product in granular form is beneficial for transportation and storage of larger quantities of active content in the polymer product than when the polymer product is not in granular form. Producing the polymer product in granular form may also allow the polymer product to contain polymer having a higher weight average molecular weight than possible in other forms of the polymer product, leading to improved performance of the polymer in its applications, such as a flocculant in a papermaking process.

In an embodiment, the polymer product contains vinylcarboxamide-containing polymer having a weight average molecular weight of from about 5,000 Daltons to about 5,000,000 Daltons, alternatively from about 100,000 Daltons to about 2,000,000 Daltons, alternatively from about 250,000 Daltons to about 750,000 Daltons. In an embodiment, the polymer product contains acrylamide-containing polymer having a weight average molecular weight of from about 500,000 Daltons to about 1,500,000 Daltons, alternatively from about 500,000 Daltons to about 1,000,000 Daltons, alternatively from about 750,000 Daltons to about 1,250,000 Daltons. Notably, the weight average molecular weight of the polymer product is higher than the weight average molecular weight of a polymer product produced through a conventional gel polymerization process that does not use a UV-only initiator and a UV light source. A higher weight average molecular weight is beneficial to enable improved performance of the polymer product in its applications, such as a flocculant in a papermaking process.

Although the polymer product may be produced in the form of a gel, the polymer product may undergo subsequent cutting and drying, resulting in a granulated polymer product that is soluble in an aqueous solution. Any amount of the granulated polymer product that does not dissolve in an aqueous solution but instead remains as a gel is referred to as “polymer solution gel.” As used herein, the term “polymer solution gel” refers to the amount of undissolved, gel-like particles that are present in a solution of the granulated polymer product. In embodiments, a 0.5 weight % solution of the granulated polymer product has a polymer solution gel of less than about 0.5 g, alternatively less than about 0.3 g, alternatively from about 0.0 g to about 1.0 g, based on 9.0 g of the polymer product, as determined via water jet pump filtration over a 150 μm Schopper-Riegler sieve. Notably, the polymer solution gel of the granulated polymer product is lower than the polymer solution gel of a granulated polymer product with comparable active content and weight average molecular weight produced through a conventional gel polymerization process that does not use a UV-only initiator and a UV light source. A lower polymer solution gel is beneficial because any particles that are present in the gel-like state in the solution are insoluble and therefore ineffective in the applications of the polymer product. A lower polymer solution gel equates to a higher yield of usable product and a higher production efficiency.

It is to be appreciated that any or all of the components above (e.g. monomers, modifiers, etc.) may be prepared or otherwise obtained (e.g. from commercial sources). Moreover, such components and/or the reagents used to prepare the same may originate from traditional (e.g. fossil-based) sources, or instead may be bio-based, i.e., prepared using biological methods and/or from products of such methods. In some embodiments, the method utilizes all bio-based components in the preparation of the vinylamine containing polymers. In other embodiments, at least a portion of a component is bio-based.

The following examples are intended to illustrate the methods for producing vinylamine-containing polymer solutions as described herein, and are not to be viewed as limiting.

### EXAMPLES

### Examples 1-3

To a standard polymerization vessel were added, in the order listed, 2.5 grams (g) of Trilon®C (10 weight % solution of diethylenetriaminepentaacetic acid), 455.2 g of a 50 weight % aqueous acrylamide solution, 120 g of an 80 weight % (2-acryloyloxy-ethyl)-trimethylammonium chloride (DMA3Q) solution, and 416.1 g of water. The amounts described resulted in a reaction mixture with a 32 weight % active content. A 50 weight % sulfuric acid solution was added to the reaction mixture until the pH of the reaction mixture reached 5.0. Initiator and formic acid were added in the amounts shown in Table 1 with V50 being 2,2′-azobis(2-methylpropionamidine) dihydrochloride. Then, the reaction mixture was cooled to −5° C. and oxygen was removed by purging the polymerization vessel with nitrogen.

Polymerization was initiated by applying UV light from a UV tube light source (Philips Cleo Performance 40W) at a distance between the UV tube light source and the reaction mixture which resulted in an intensity measurement, as measured at the location of the reaction mixture using a UV meter, of about 1200 μW/cm². The temperature of the reaction mixture was monitored, and when the temperature of the reaction mixture reached 60° C., the distance between the UV tube light source and the reaction mixture was decreased until the intensity of the UV tube light source was about 6000 μW/cm², as measured at the location of the reaction mixture using a UV meter.

Within several minutes, the temperature of the reaction mixture rose from about −5° C. to about 80° C. The resulting polymer product was in the form of a gel. The gelatinous polymer product was cut with a meat grinder. The cut polymer product was then dried in an environment having a temperature of 120° C. for 10 minutes, then in an environment having a temperature of 100° C. for 30 minutes, then in an environment having a temperature of 90° C. for 40 minutes. Then, using an ultra-centrifugal mill, the dried polymer product was ground to a particle-size of about 100 microns to about 1000 microns as measured by filtering the particles through sieves having apertures of varying sizes.

The Examples resulting from the above described procedures are designated Examples 1-3. Examples designated as “Comp. Ex” are comparative examples not in accordance with the present disclosure.

### Example 4

The polymerization procedure described above for Examples 1-3 was followed, except that instead of a UV tube light source, a UV LED module (with 3-5 365 nm diodes with 3.5 W) was used to initiate the polymerization. The intensities were also different from Examples 1-3. The starting intensity was about 140 μW/cm², and when the temperature of the reaction mixture reached about 60° C., the intensity was adjusted to about 8500 μW/cm².

The drying and grinding procedure described in Examples 1-3 was followed to form the polymer product into granular form, with the resulting example being designated Example 4. Examples designated as “Comp. Ex” are comparative examples not in accordance with the present disclosure.

### Examples 5-9

The polymerization procedure described above for Examples 1-3 was followed, except that for Examples 6-9, instead of a UV tube light source, a UV LED module (with 3-5 365 nm diodes with 3.5 W) was used to initiate the polymerization as described above for Example 4. The intensities described above for Example 4 were used for Examples 6-9.

The amounts of each component added to the reaction mixture as described above for Examples 1-3 created a reaction mixture with an active content of 32 weight %, represented by Examples 5-7. To create Examples 8-9, the amount of acrylamide solution and DMA3Q solution added was increased, and the amount of water added was decreased as needed to achieve the active content listed in Table 1.

Further, for Examples 5-7 and Example 9, 2-hydroxy-2-methyl-1-phenyl-1-propanone (HMPP) was added to the reaction mixture instead of V50. The HMPP was added to the reaction mixture in an amount of 0.6 g.

The drying and grinding procedure described in Examples 1-3 was followed to form the polymer product into granular form, with the resulting examples being designated Examples 5-9. Examples designated as “Comp. Ex” are comparative examples not in accordance with the present disclosure.

### Examples 10-14

The polymerization procedure described above for Examples 1-3 was followed, except that, for Examples 12 and 14, instead of a UV tube light source, a UV LED module (with 3-5 365 nm diodes with 3.5 W) was used to initiate the polymerization as described above for Example 4. The intensities described above for Example 4 were used for Examples 12 and 14.

Further, for Examples 13-14, 2-hydroxy-2-methyl-1-phenyl-1-propanone (HMPP) was added to the reaction mixture instead of V50. The HMPP was added to the reaction mixture in an amount of 0.6 g. The amount of water added to the reaction mixture was increased or decreased as needed to achieve the active content listed in Table 1.

The drying and grinding procedure described above for Examples 1-3 was followed to form the polymer product into granular form, with the resulting examples being designated Examples 10-14. Examples designated as “Comp. Ex” are comparative examples not in accordance with the present disclosure.

The results of Examples 1-13 are shown in Table 1 below.

TABLE 1
Effect of UV-Only Initiator on Viscosity and Polymer Solution Gel

| | | | | Formic | | | | Dynamic | | |
|---|---|---|---|---|---|---|---|---|---|---|
| | Active | | Initiator | Acid | | Max | Polymer | Viscosity | UL | Residual |
| | Content | Initiator | Amount | Amount | Light | Temp | Solution | 1% Solution | Viscosity | Monomers |
| | (weight %) | Type | (mg/kg) | (mg/kg) | Source | (° C.) | Gel (g) | (mPas) | (mPas) | (mg/kg) |
| Comp. Ex. 1 | 32 | V50 | 500 | 100 | Tube | 76 | 0.1 | 1180 | 4.3 | 575 |
| Comp. Ex. 2 | 32 | V50 | 500 | 80 | Tube | 76 | 0.1 | 1460 | 4.7 | 410 |
| Comp. Ex. 3 | 32 | V50 | 600 | 25 | Tube | 76 | 0.3 | 2000 | 5.2 | 20 |
| Comp. Ex. 4 | 32 | V50 | 500 | 25 | LED | 75 | 0.25 | 2072 | 5.8 | 45 |
| Ex. 5 | 32 | HMPP | 600 | 25 | Tube | 74 | 0.3 | 1800 | 5.3 | 20 |
| Ex. 6 | 32 | HMPP | 600 | 15 | LED | 73 | 0.3 | 2100 | 5.6 | 20 |
| Ex. 7 | 32 | HMPP | 600 | 0 | LED | 74 | 0.3 | 2470 | 5.9 | 20 |
| Comp. Ex. 8 | 35 | V50 | 600 | 40 | LED | 87 | 0.1 | 1770 | Not | 30 |
| | | | | | | | | | determined | |
| Ex. 9 | 35 | HMPP | 600 | 40 | LED | 87 | 0.0 | 2008 | Not | <20 |
| | | | | | | | | | determined | |
| Comp. Ex. 10 | 40 | V50 | 500 | 100 | Tube | 104 | 2 | 990 | 3.6 | 180 |
| Comp. Ex. 11 | 40 | V50 | 250 | 200 | Tube | 103 | 0.2 | 800 | 3.5 | 845 |
| Comp. Ex. 12 | 40 | V50 | 500 | 30 | LED | 106 | 1.1 | 1536 | 4.7 | 845 |
| Ex. 13 | 38 | HMPP | 600 | 30 | Tube | 90 | 100 | 2000 | 4.8 | 100 |
| Ex. 14 | 38 | HMPP | 600 | 20 | LED | 95 | 0.1 | 2060 | 5.6 | 20 |

The polymer solution gel value was determined by dissolving and mixing 9 g the dried, granulated polymer product in water to produce a 0.5 weight % aqueous solution of the polymer product. Then, the solution was poured over a 150 μm Schopper-Riegler sieve under vacuum. After the solution passed through the sieve, the sieve was rinsed with water, excess water was absorbed with a paper towel, and the net weight of the material remaining on the sieve was measured. The dynamic viscosity was determined by dissolving the dried, granulated polymer product in water to create a 1 weight % aqueous solution of the polymer product, with 10 weight % sodium chloride in the solution, based on a total weight of the solution. Then, the dynamic viscosity was measured using a Brookfield viscometer at 10 rpm using an LV spindle number 2 at 20° C. The UL viscosity was determined by creating a 0.1 weight % solution of the polymer product, based on a total weight of the solution, in 1M NaCl. Then, the UL viscosity was measured using a Brookfield viscometer model LVT with a UL adapter at 60 rpm using an LV spindle number 2 at 25° C.

The results in Table 1 demonstrate the effects of using an initiator that is activated only by UV light. For example, when HMPP initiator was used instead of V50 initiator, with 35 weight % active content and a UV LED, the HMPP initiator resulted in a polymer product with a lower polymer solution gel value, a higher dynamic viscosity, and a lower amount of residual monomers than a polymer product produced through the same process but with V50 initiator.

### Example 15

To a standard polymerization vessel were added, in the order listed, 2.5 g of Trilon®C, 506.7 g of 50 weight % aqueous acrylamide solution, 132 g of 60 weight % (3-acrylamidopropyl)trimethylammonium chloride (DIMAPA-Q) solution, and 530.3 g of water. A 50 weight % sulfuric acid solution was added to the reaction mixture until the pH reached 4.5. V50 and formic acid were added to the reaction mixture in the amounts shown in Table 2. Then, the reaction mixture was cooled to −5° C. and oxygen was removed by purging the polymerization vessel with nitrogen. Polymerization was initiated by applying UV light from a UV tube light source (Philips Cleo Performance 40W) at an intensity of about 6000 μW/cm².

Within several minutes, the temperature of the reaction mixture rose from about −5° C. to about 80° C. The resulting polymer product was in the form of a gel. The gelatinous polymer product was cut with a meat grinder. The cut polymer product was then dried at 120° C. for 10 minutes, then at 100° C. for 30 minutes, then at 90° C. for 40 minutes. Then, using an ultra-centrifugal mill, the dried polymer product was ground to a particle-size fraction of about 100 microns to about 1400 microns as measured using sieve analysis.

### Example 16 and 17

To a standard polymerization vessel were added, in the order listed, 2.5 g of Trilon®C, 583.4 g of 50 weight % aqueous acrylamide solution, 152 g of 60 weight % (3-acrylamidopropyl)trimethylammonium chloride (DIMAPA-Q) solution, and 254.1 g of water. A 50 weight % sulfuric acid solution was added to the reaction mixture until the pH reached 4.5. V50 and formic acid were added to the reaction mixture in the amounts shown in Table 2. Then, the reaction mixture was cooled to −5° C. and oxygen was removed by purging the polymerization vessel with nitrogen. Polymerization was initiated by applying UV light from a UV LED module (with 3-5 365 nm diodes with 3.5 W). The starting intensity was about 1200 μW/cm². When the temperature of the reaction mixture reached about 70° C., the intensity was adjusted to about 5700 μW/cm². After the maximum temperature of the reaction mixture was reached, as monitored by a temperature probe in the reaction mixture, the intensity was adjusted to about 9000 μW/cm², and the UV light was applied at this final intensity for about 30 minutes.

Within several minutes, the temperature of the reaction mixture rose from about −5° C. to about 99° C. The resulting polymer product was in the form of a gel. The gelatinous polymer product was cut with a meat grinder. The cut polymer product was then dried at 120° C. for 10 minutes, then at 100° C. for 30 minutes, then at 90° C. for 40 minutes. Then, using an ultra-centrifugal mill, the dried polymer product was ground to a particle-size fraction of about 100 microns to about 1400 microns as measured using sieve analysis.

The results of Examples 15-17 are shown in Table 2 below.

TABLE 2
Acrylamide Copolymers with DIMAPA-Q

| | Active | | Formic | | Polymer | |
|---|---|---|---|---|---|---|
| | Content | V50 | Acid | Light | Solution | Viscosity |
| | (weight %) | (ppm) | (ppm) | Source | Gel (mL) | (mPas) |
| Comp. Ex. 15 | 33 | 500 | 150 | Tube | 22 | 885 |
| Comp. Ex. 16 | 33 | 500 | 100 | LED | 5 | 805 |
| Comp. Ex. 17 | 38 | 500 | 150 | LED | 15 | 785 |

The polymer solution gel value and the dynamic viscosity were measured by the same methods described above for Examples 1-14.

### Examples 18-19

For Example 18, to a standard polymerization vessel were added, in the order listed, 2.5 grams (g) of Trilon®C (10 weight % solution of diethylenetriaminepentaacetic acid), 227.3 g of a 50 weight % aqueous acrylamide solution, 421.9 g of an 80 weight % (2-acryloyloxy-ethyl)-trimethyylammonium chloride (DMA3Q) solution, and 347 g of water. A 50 weight % sulfuric acid solution was added to the reaction mixture until the pH of the reaction mixture reached 5.

For Example 19, to a standard polymerization vessel were added, in the order listed, 2.5 grams (g) of Trilon®C (10 weight % solution of diethylenetriaminepentaacetic acid), 252.5 g of a 50 weight % aqueous acrylamide solution, 468.8 g of an 80 weight % (2-acryloyloxy-ethyl)-trimethyylammonium chloride (DMA3Q) solution, and 275.4 g of water. A 50 weight % sulfuric acid solution was added to the reaction mixture until the pH of the reaction mixture reached 5.

Then, for Examples 18 and 19, formic acid and initiator were added in the amounts shown in Table 3 with V50 being 2,2′-azobis(2-methylpropionamidine) dihydrochloride. The reaction mixture was cooled to −5° C., and oxygen was removed by purging the polymerization vessel with nitrogen.

Polymerization was initiated by applying UV light from a UV LED module (with 365 nm LEDs with 3.5 W) at an intensity of about 140 μW/cm². The temperature of the reaction mixture was monitored, and when the temperature of the reaction mixture reached 60° C., the intensity of the UV tube light source was increased to about 8500 μW/cm².

The drying and grinding procedure described in Examples 1-3 was followed to form the polymer product into granular form, with the resulting examples being designated Examples 18-19. Examples designated as “Comp. Ex” are comparative examples not in accordance with the present disclosure.

### Examples 20 and 21

The polymerization procedure described above for Example 18 was followed for Example 20, and the polymerization procedure described above for Example 19 was followed for Example 21, except that 2-hydroxy-2-methyl-1-phenyl-1-propanone (HMPP) was added to the reaction mixture instead of V50. The HMPP was added to the reaction mixture in the amounts shown in Table 3 below.

The drying and grinding procedure described in Examples 1-3 was followed to form the polymer product into granular form, with the resulting examples being designated Examples 20-21. Examples designated as “Comp. Ex” are comparative examples not in accordance with the present disclosure.

TABLE 3
Effect of UV-Only Activated Initiator on High Charged Cationic Polyacrylamide

| | Active | | Amount of | Amount of | Dynamic | Polymer | Residual |
|---|---|---|---|---|---|---|---|
| | Content | | Formic Acid | Initiator | Viscosity | Solution | Monomers |
| | (weight %) | Initiator | (pm) | (ppm) | (mPas) | Gel (mL) | (ppm) |
| Comp Ex. 18 | 45 | V50 | 0 | 350 | 1570 | 7 | 55 |
| Comp. Ex. 19 | 50 | V50 | 0 | 350 | 1388 | 7 | 305 |
| Ex. 20 | 45 | HMPP | 10 | 200 | 1900 | 18 | 50 |
| Ex. 21 | 50 | HMPP | 0 | 300 | 1700 | 11 | 440 |

The results in Table 3 demonstrate that when a UV-only activated initiator is used instead of a heat-activated azo initiator at an active content of 45-50 weight %, the resulting polymer product has a higher dynamic viscosity.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment of the present disclosure. It being understood that various changes may be made in the function and arrangement of elements described in an exemplary embodiment without departing from the scope of the present disclosure as set forth in the appended claims.

What is claimed is:

1. A method of synthesizing a polymer product, the method comprising the steps of:
(a) combining an ultraviolet light-activated polymerization initiator and a nitrogen-containing vinyl monomer to form a reaction mixture, wherein the initiator is radicalized only by exposure to ultraviolet light, and wherein the reaction mixture has an active content of reactive components present in an amount of at least about 20 weight % based on a total weight of the reaction mixture;
(b) exposing the reaction mixture to ultraviolet light produced from an ultraviolet light source to form the polymer product comprising a reaction product of the initiator and the nitrogen-containing vinyl monomer, wherein the polymer product is comminutable to form discrete granules of the polymer product.

2. The method of claim 1, wherein the ultraviolet light-activated polymerization initiator and the nitrogen-containing vinyl monomer are combined to form the reaction mixture having an active content of reactive components present in an amount of at least about 28 weight % based on the total weight of the reaction mixture.

3. The method of claim 1, wherein the reaction mixture is exposed to the ultraviolet light produced from the ultraviolet light source having a wavelength from about 350 nm to about 370 nm.

4. The method of claim 1, wherein the reaction mixture is exposed to the ultraviolet light produced from the ultraviolet light source having a wavelength from about 360 nm to about 370 nm.

5. The method of claim 1, wherein the ultraviolet light source is an ultraviolet light-emitting diode, and wherein the reaction mixture is exposed to the ultraviolet light produced from the ultraviolet light-emitting diode.

6. The method of claim 1, wherein the nitrogen-containing vinyl monomer is combined with the ultraviolet light-activated polymerization initiator selected from the group of 2-Hydroxy-2-methyl-1-phenyl-1-propanone, benzophenone, 4′-Hydroxyacetophenone, methyl benzoylformate, 2,2-Dimethoxy-2-phenylacetophenone, alpha-ketoglutaric acid, Camphorquinone, (1-Hydroxycyclohexyl)-phenylketone, 2-Hydroxy-4-(2-hydroxyethoxy)-2-methylpropiophenone, ethyl 2-oxopropanoate, ethyl 3-methyl-2-oxobutanoate, 4,4-dimethyldihydrofuran-2,3-dione, ethyl phenylglyoxylate and combinations thereof.

7. The method of claim 1, wherein the ultraviolet light-activated polymerization initiator and the nitrogen-containing vinyl monomer are combined with a co-initiator.

8. The method of claim 1, wherein the reaction mixture is exposed to the ultraviolet light produced from the ultraviolet light source at least until a gel point is reached.

9. The method of claim 1, further comprising comminuting the polymer product to form discrete granules of the polymer product.

10. The method of claim 1, wherein the ultraviolet light-activated polymerization initiator is combined with the nitrogen-containing vinyl monomer comprising an acrylamide monomer.

11. The method of claim 10, wherein the ultraviolet light-activated polymerization initiator and the acrylamide monomer are combined with an additional nitrogen-containing vinyl monomer selected from the group of diallyldimethylammonium chloride, acrylamidopropyltrimethyl ammonium chloride, methacrylamidopropyltrimethyl ammonium chloride, quaternary ammonium salts of dimethylaminoethyl acrylate, quaternary ammonium salts of dimethylaminoethyl methacrylate, and combinations thereof.

12. The method of claim 10, wherein the reaction mixture is exposed to the ultraviolet light produced from the ultraviolet light source to form the polymer product having a weight average molecular weight of at least about 1,000,000 Daltons.

13. The method of claim 10, further comprising selectively modulating the ultraviolet light source.

14. The method of claim 13, wherein modulating the ultraviolet light source comprises increasing the intensity of the ultraviolet light source once the reaction mixture reaches a temperature of from about 10° C. to about 30° C. below a maximum temperature of the reaction mixture.

15. The method of claim 1, wherein the ultraviolet light-activated polymerization initiator is combined with the nitrogen-containing vinyl monomer selected from one or more N-vinylcarboxamide monomers having the general formula I 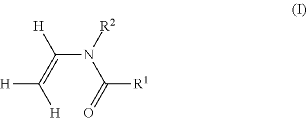
wherein R¹ and R², independently of one another, are H or C₁ to C₆ alkyl groups.

16. The method of claim 15, further comprising maintaining a temperature of the reaction mixture at less than about 80° C. for the duration of the reaction.

17. The method of claim 15, further comprising maintaining a temperature of the reaction mixture at less than about 70° C. to about 80° C. for the duration of the reaction.

18. The method of claim 16, wherein maintaining the temperature of the reaction mixture comprises selectively modulating the ultraviolet light source.

19. The method of claim 15, wherein the reaction mixture is exposed to the ultraviolet light produced from the ultraviolet light source, and further comprising comminuting the polymer product to form discrete granules of the polymer product, wherein functional groups in the polymer product are hydrolyzed to form primary amine functional groups present in the hydrolyzed polymer product having a weight average molecular weight of at least about 250,000 Daltons.

20. The method of claim 1, wherein the reaction mixture having an active content of reactive components present in an amount of at least about 28 weight % based on the total weight of the reaction mixture is exposed to the ultraviolet light produced from the ultraviolet light-emitting diode light source having a wavelength from about 350 nm to about 370 nm, at least until the gel point is reached.
